(19) United States
(12) Patent Application Publication
(10) Pub. No.: US 2009/0327322 A1
(43) Pub. Date: Dec. 31, 2009

(54) INFORMATION WORKER CREATING COMPONENT APPLICATION WITHOUT WRITING CODE TO CREATE THE APPLICATIONS

(75) Inventors: Gurdeep Singh Pall, Medina, WA (US); Christopher H. Pratley, Seattle, WA (US); Ajitesh Kishore, Kirkland, WA (US); Lewis C. Levin, Seattle, WA (US); Parichay Saxena, Bellevue, WA (US); Patrice Y. Simard, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/148,000

(22) Filed: Jun. 27, 2008

(51) Int. Cl. G06F 17/30

(52) U.S. Cl. 707/101; 707/E17.009

(57) ABSTRACT

A data processing system for data exchange across application boundaries is provided. The system includes a canvas memory in which to open multiple applications. A transform component generates data structures across the canvas memory in at least one application form and automatically transforms the data structures to at least one other application form to mitigate application boundaries between disparate applications.

### BACKGROUND

A long standing goal of the software development industry has been the desire to write seamless and transparent applications that are not constrained by the nuances of any one application. Thus, a graphical software design system should be able to exchange data with a text application without having to write any particular code to integrate the data with one system or another or employ any special rules to utilize the data. In one sense, an abstract model may be preferred yet these types of models are usually employed for conceptual designs as opposed to that actual exchange of information between disparate applications. An abstract model (or conceptual model) is a theoretical construct that represents some aspect of a problem, with a set of variables and a set of logical and quantitative relationships between them. Models in this sense are constructed to enable reasoning within an idealized logical framework about various processes and are an important component of high level design. Idealized here implies that the model may make explicit assumptions that are known to be false (or incomplete) in some detail. Such assumptions may be justified on the grounds that they simplify the model while, at the same time, allowing the production of acceptably accurate solutions in some other form.

Current design implementations for software data models are typically achieved in the context of a software development environment or system. Such systems provide multiple design packages that are integrated within a common interface framework where developers can layout their data structures, define such structures, and determine the types of interfaces that are to be employed when manipulating data within the structures. This often includes determining how an object updates its respective data and how are methods invoked that operate on the object. This may involve planning how objects within a particular program communicate with other objects within the same program and how remote network objects may also communicate with the program. If completely different styles of programs (e.g., database program versus graphical design program) are to communicate data however, specific code must be written to account for the nuance differences of one program in view of one or more other programs. Thus, whole new software developments are often undertaken just to exchange data between respective applications that have diverse data handling requirements.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A generic data model is provided that allows authoring and processing data across applications in a seamless manner. For example, such applications include cloud-based services, Internet domains, spreadsheet applications, word processing applications that enable viewing/using data in the best possible environment of the designer's choice. The data can be operated upon without having to switchover to some other application to act on data regardless of the source or of application boundaries. This includes source free processing of data, creating applications from multiple sources, automatically switching between presentations, text, spreadsheet, and so forth without writing new code to achieve such tasks. For example, the generic or transparent models provide an office environment or workplace where there are no hard boundaries between applications. Thus, in one aspect, a unified canvas is employed to view and operate on data without additional software to account for differences between applications.

In another aspect, an information worker component can access/process data across multiple domains such as from cloud services, web domains, and from unstructured data sources in a seamless and efficient manner. As data is collected, the data is rendered in an application-independent format, where the collected or aggregated data is then operated upon as a singular unit. Thus, a generic model is created where data can be collected across office software products for example without concern for the nuances of the given product. From the generic model, applications are then constructed thus alleviating the need to write code to collect data from disparate applications.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a system for determining and processing data between disparate applications.

FIG. 2 is a block diagram that illustrates example data transformation aspects.

FIG. 3 illustrates layout type to data type bindings for a canvas application.

FIG. 4 illustrates how application states are shared across application boundaries via a canvas.

FIG. 5 illustrates an example learning system for processing applications in accordance with a universal canvas.

FIG. 6 illustrates an exemplary system that employs wrappers to communicate across application boundaries.

FIG. 7 illustrates an example development system to deploy applications on to a universal canvas.

FIG. 8 illustrates an exemplary process for sharing data in a generic manner across disparate application boundaries.

FIG. 9 is a schematic block diagram illustrating a suitable operating environment.

FIG. 10 is a schematic block diagram of a sample-computing environment.

### DETAILED DESCRIPTION

Systems and methods are provided for processing data across disparate applications in a seamless and efficient manner. In one aspect, a data processing system for data exchange across application boundaries is provided. The system includes a canvas memory in which to open multiple applications. A transform component generates data structures across the canvas memory in at least one application form and automatically transforms the data structures to at least one other application form to mitigate application boundaries between disparate applications. In another aspect, the canvas memory functions as a background buffer component in a computer system or exists inside of one application that can be accessed by at least one other application.

As used in this application, the terms “component,” “application,” “canvas,” “model,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

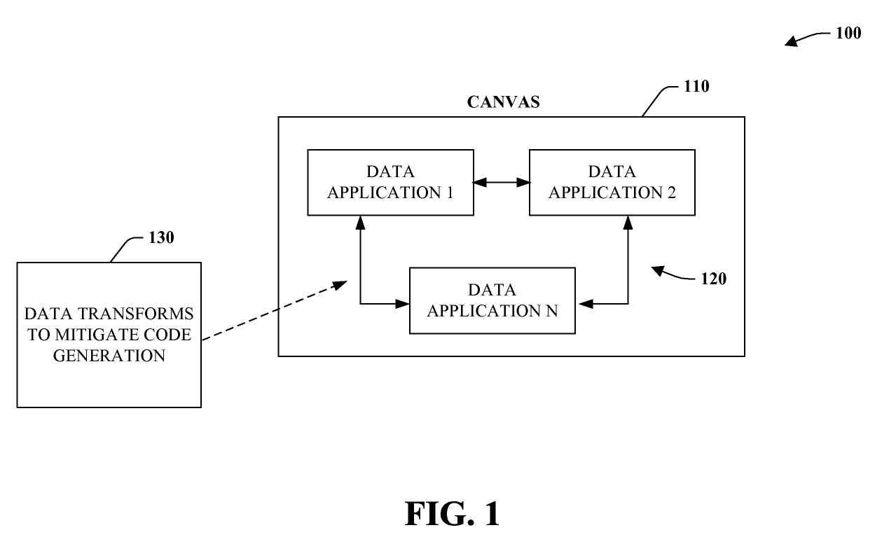

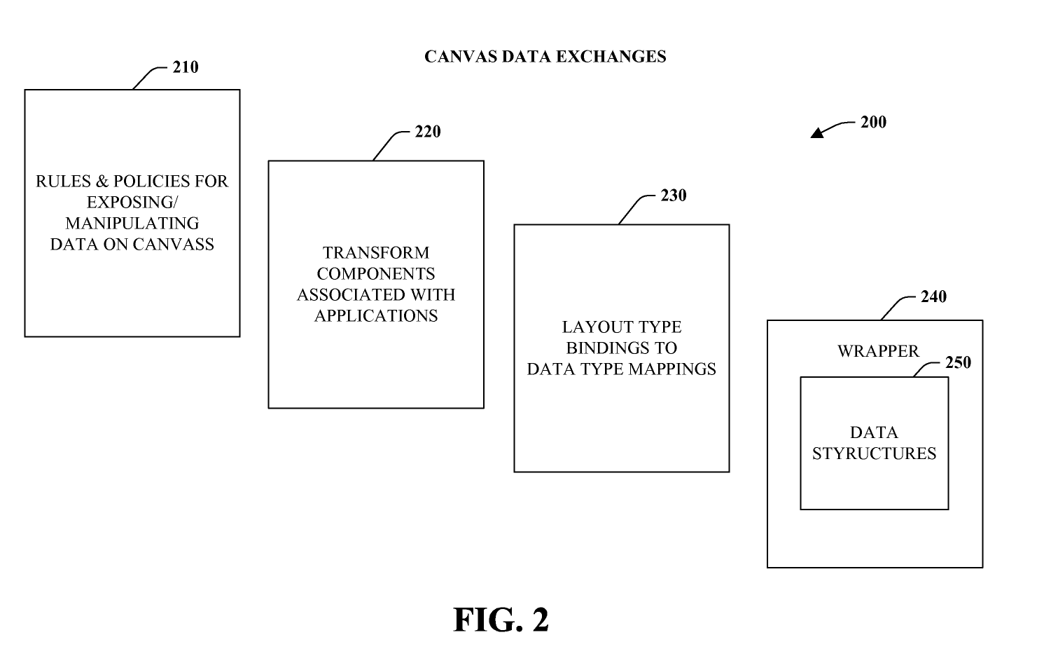

Referring initially to FIG. 1, a system 100 is illustrated for processing data across application boundaries. The system 100 can be employed for data exchange across application boundaries where a canvas memory 110 is provided in which to open multiple data applications 120 (shown as applications 1-N) where N is an integer and application may also be referred to as the application. A transform component 130 generates data structures across the canvas memory 110 in at least one application form and automatically transforms or converts the data structures to at least one other application form to mitigate or remove application boundaries between applications. In one aspect, the canvas memory 110 functions as a background buffer component in a computer system where data applications 120 are aggregated to exchange data. In another aspect, the canvas memory 110 can exist inside of one application 120 that can be accessed by at least one other application. As will be described in more detail below with respect to FIG. 2, application boundaries can be removed or mitigated via generic data processing rules for exchanging data across the canvas memory 110, via transformation from one application form to a form supported universally by the canvas, via layout type/data type bindings, and/or via wrapping components that hide the nuances of a data structure yet expose data contents of such structures in a generic manner that is seamless across data and application boundaries.

In general, the system 100 can be utilized as an automated information worker to access data across multiple domains such as from cloud services, web domains, and from unstructured data sources, for example. As data is collected, the data is rendered in an application-independent format, where the collected or aggregated data is then operated upon as a singular unit within the canvas memory 110. Thus, a generic model is created where data can be collected across office products for example without concern for the nuances of the given product. From the generic model, the applications 120 are then constructed thus alleviating the need to write code to collect data from such disparate applications.

Data can be authored and processed across the applications 120 in a seamless manner, where such data can be associated with cloud-based services, Internet domains, spreadsheets, text applications and so forth in order to view/process data on the best possible development environment. The canvas memory 110 allows data to be acted upon without having to switchover to some other application and regardless of source of application boundaries. This includes source free processing of data, taking office software to different levels, creating applications 120 from multiple sources, automatically switching between presentation applications, word applications, spreadsheets, and so forth without writing code. This provides office environments or workplaces where there are no hard boundaries between applications, a unified canvas 110 in which to view data without having different applications to process shared states. For example, forecasted data to understand who has accessed a database in the past month, and so forth.

Links can be embedded regarding the source of data that allows one to drill down to bring up those portions of an application 120 that may be necessary such as a spreadsheet to process a certain data structure. Data can be tagged from where it came, removing applications boundaries in terms of content, maintaining state across applications, making data live within portions of the canvas 110, and then providing multiple views of the respective data. When rendering to personal computer (PC), the richness of the PC can be employed but when rendering to a cell phone (or other device) consider limitations of the phone. Thus, new data containers can be created since application boundaries no longer exist, where state and data is maintained along the universal canvas 110 which allows data sharing and state across applications and viewers.

As will be described in more detail below, data can be placed in front of the user that is most likely to be the next piece of data they need via pre-fetching user interface. For instance, what should appear next and what exactly should be shown. Presence information of users can be employed and leveraged off such information. Since every document and application is loaded, the canvas 130 determines how to filter out what is not needed. Thus, filtering may be employed that hides data that may not be relevant to a current context. This can be inferred from present states for example and includes aspects such as how do user metaphors change if documents and applications are substantially always loaded.

Referring now to FIG. 2, example data transformation aspects 200 are illustrated. In one aspect, one or more rules or policies 210 can be provided that distribute clues or other information on the canvas (or other memory structure) on how to exchange data between various disparate applications. This can include providing rules or policies to an application on how to format data, how to transmit and receive data on the canvas, what type of data structures may be employed, what other type of application interfaces are available, what types of memory allocations are available, what data types may be in play, and substantially any rule or policy that communicates information to an application entering on to the canvass how to communicate with some other application that currently resides on the canvas.

In a related aspect, rules or policies can be derived by external components that monitor the canvas. For instance, one or more learning components can be employed to generate rules and policies 210 for the canvas. The learning components can also be utilized to determine potential interface or other mappings that can be employed by disparate data components to communicate on the canvas. This can include substantially any type of learning process that monitors data transactions over time to determine how to exchange data with subsequent applications. Also, learning components can be trained from independent sources such as from administrators who generate information, where the learning components are trained to automatically generate data based on past actions of the administrators. The learning components can also be fed with predetermined data such as controls that weight such aspects as key words or word clues that may influence data exchanges on the canvas. Learning components can include substantially any type of artificial intelligence component including neural networks, Bayesian components, Hidden Markov Models, Classifiers such as Support Vector Machines and so forth. It is noted that the learning components serve at least two functions: 1) learning associated with the native data/application—where over a period of time the components determine which transforms have happened (potentially caching them for faster rendering) and 2) learning associated on the ‘canvas’ that supports pre-fetching based on history.

Proceeding to 220, transform components can be associated with applications when they are exposed to the canvas. For instance, upon first communications with the canvas, a data application can be instructed on how to format data when sending data to the canvas and what to expect when receiving data from the canvas. Thus, the application interacting with the canvas is provided with a generic interface that allows exchanging data from one application to another in an application-independent manner. This can include providing codes for different data types and structures, the amount of data that can be exchanged or stored on the canvas, the type of interfaces supported, various mappings that may be available between types and so forth.

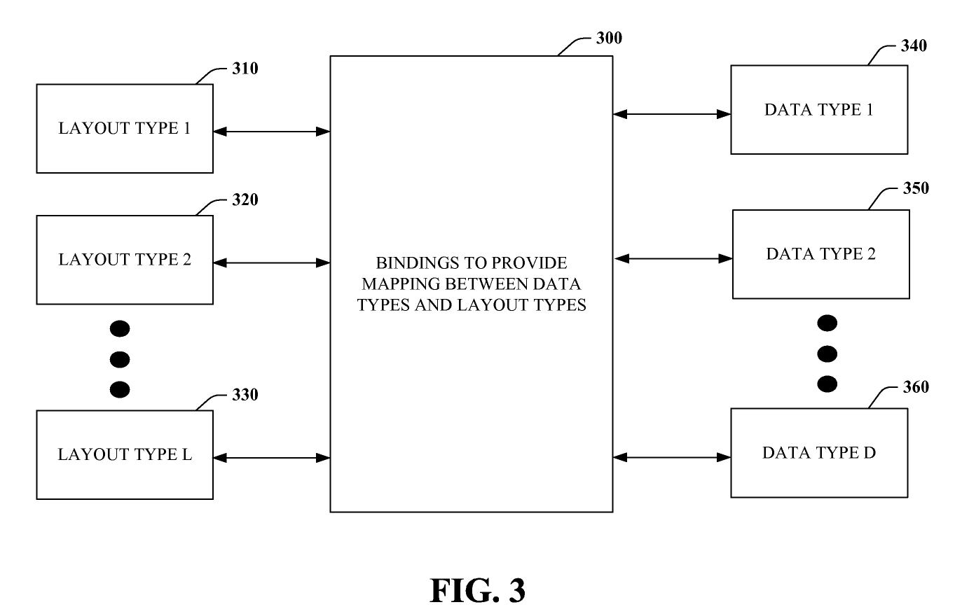

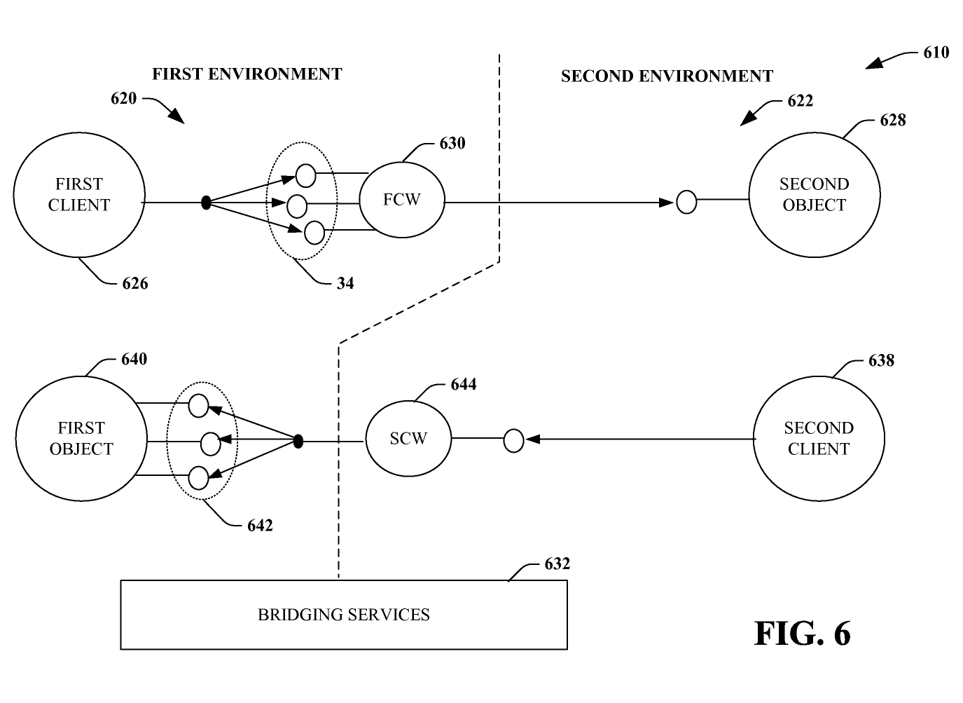

At 230, layout type bindings can be provided to enable mappings between one or more layout types and one or more data types. The bindings describe rules or other information on how to map data that is presented in one form to data types that may be associated with an alternative form. Such bindings are described in more detail with respect to FIG. 3. At 240, wrappers may be employed when communicating between disparate data applications. Such wrappers shield various applications from the nuances of other applications interfaces and are described in more detail below with respect to FIG. 6. Thus, a data structure 250 may be wrapped at 240, where the wrapper communicates with the canvas yet hides the internal interactions and nuances of the data structure from the canvas.

Turning to FIG. 3, layout type to data type bindings for a canvas application are illustrated at 300. In this aspect, various bindings or binding rules are provided that describe how to map one or more data layout types 310-330 with one or more data types 340-360. A layout describes the mapping of a file's data to the storage components that hold the data, where a layout is said to belong to a specific “layout type.” The layout type allows for variants to handle different storage protocols (e.g., block/volume, object, and file layout types). A metadata component, along with its control protocol, supports at least one layout type. A private sub-range of the layout type name space can also be defined. Values from the private layout type range can be used for internal testing or experimentation.

As an example, a file layout type could be an array of tuples (e.g., deviceID, file_handle), along with a definition of how the data is stored across the devices (e.g., striping). A block/volume layout can be an array of tuples that store <deviceID, block_number, block count> along with information about block size and the file offset of the first block. An object layout can be an array of tuples <deviceID, objectID> and an additional structure (i.e., the aggregation map) that defines how the logical byte sequence of the file data is serialized into the different objects. Typically, the actual layouts are more complex than these expository examples and it is to be appreciated that other types are possible.

A data type is an attribute of a portion of data that informs a processor about what aspect of data is being dealt with. This involves setting constraints on the data, such as what values that data can take on, and what operations may be performed on that data. Common data types may include: integers, floating-point numbers (decimals), and alphanumeric strings. For example, in the Java programming language, the “int” type represents the set of 32-bit integers ranging in value from −2,147,483,648 to 2,147,483,647, as well as the operations that can be performed on integers, such as addition, subtraction, and multiplication. Colors, on the other hand, are represented by three bytes denoting the amounts each of red, green, and blue, and one string representing that color's name; allowable operations include addition and subtraction, but not multiplication, for example.

In one sense, a data type defines a set of values, and the allowable operations on those values. Almost all programming languages explicitly include the notion of data type, though different languages may use different terminology. Most programming languages also allow the programmer to define additional data types, usually by combining multiple elements of other types and defining the valid operations of the new data type. For example, a programmer might create a new data type named “Person” that specifies that data interpreted as Person would include a name and a date of birth. A data type can also be thought of as a constraint placed upon the interpretation of data in a type system, describing representation, interpretation and structure of values or objects stored in computer memory. The type system uses data type information to determine correctness of computer programs that access or manipulate the data.

The binding component 300 (or components) can be associated with a canvas or other data structure to allow communications between various layout types and respective data types. It is noted that one or more data types 340-360 can be bound to one or more layout types 310-330. In another aspect, a data communications system (e.g., system 100 of FIG. 1) is provided. The system includes means for providing a layout (layout types 310-330) of one or more data structures and means for defining a type (data types 340-360) for one or more data structures. The system includes means for binding the layout and the type (binding component 300) for the one or more data structures and means for exchanging data between the data structures (e.g., canvas 110 of FIG. 1), where the data structures are associated with at least two different applications.

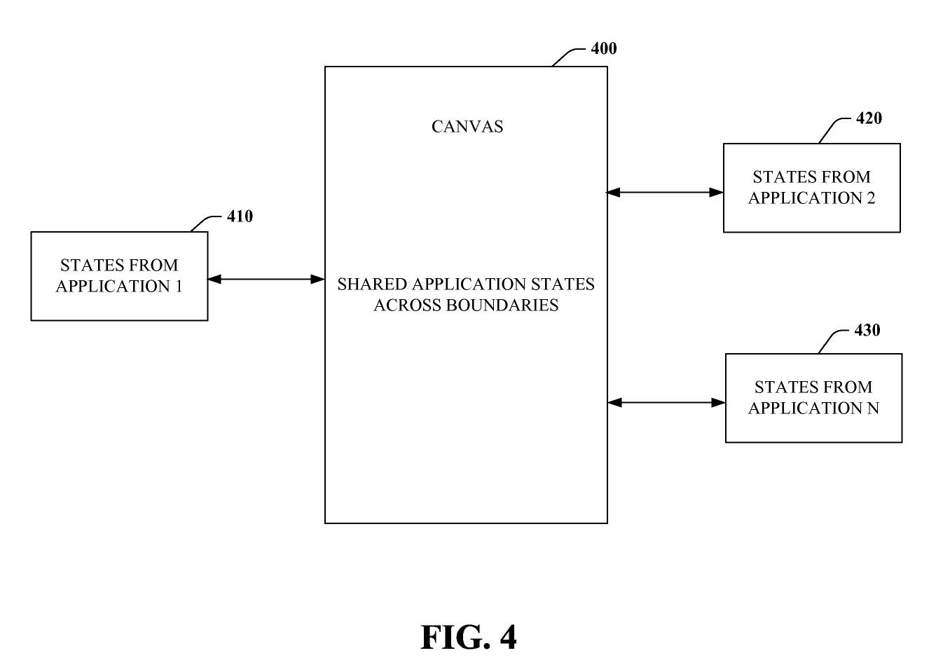

Referring now to FIG. 4, a canvas 400 illustrates how application states are shared across application boundaries. The canvas 400 can receive and communicate application states 410-430 from one or more applications which exchange data with the canvas. States can range from more simple communications canvas to more complex interactions. These can include power-up states, initialization states, reset states, hold states, transmit data states, receive data states, request for rules or policies states, requests for particular types of data, data dump states, data listen states where a general request to the canvas 400 is made and the application listens for a response to the request, request for interface states, test states where an application can run a limited test with the canvas to determine interoperability with the canvas or other applications, meta data states where requests can be made to understand a given application's metadata, expose data type states, expose layout type states, and substantially any type of state or condition that allows an application to send or receive data with the canvas or another application in a generalized manner.

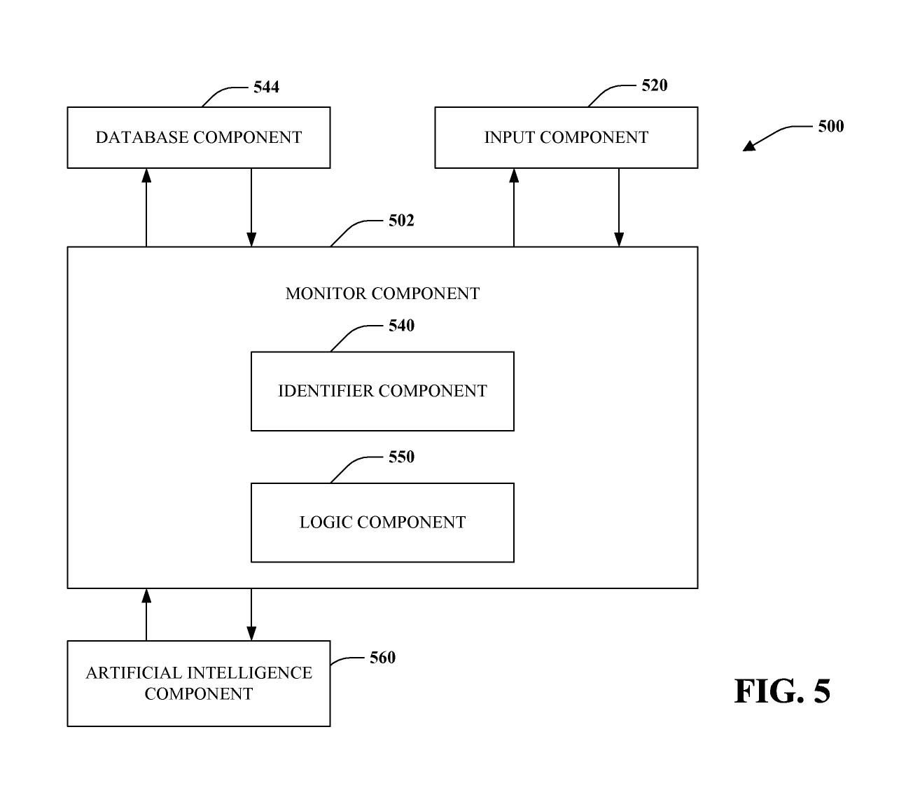

Referring to FIG. 5, a detailed system 500 employing a monitor component 502 is illustrated, where the system can automatically determine rules or policies for mapping disparate data applications via a canvas or other storage medium. The monitor component 502 receives a set of parameters from an input component 520. The parameters may be derived or decomposed from a specification provided by the user and parameters can be inferred, suggested, or determined based on logic or artificial intelligence (AI). An identifier component 540 identifies suitable steps, or methodologies to accomplish the mapping of a particular data item in accordance with the parameters of the specification. It should be appreciated that this may be performed by accessing a database component 544, which stores one or more component and methodology models. The monitor component 502 can also employ a logic component 550 to determine which data component or model to use when monitoring an application or data structure.

When the identifier component 540 has identified the components or methodologies and defined models for the respective components or steps, the monitor component 502 constructs, executes, and embeds data based upon an analysis or monitoring of a given application. In accordance with this aspect, an AI component 560 automatically generates various mappings or rules by monitoring canvas data activity. The AI component 560 can include an inference component (not shown) that further enhances automated aspects of the AI components utilizing, in part, inference based schemes to facilitate inferring data from which to monitor an application. The AI-based aspects can be affected via any suitable machine learning based technique or statistical-based techniques or probabilistic-based techniques or fuzzy logic techniques. Specifically, the AI component 560 can implement learning models based upon AI processes (e.g., confidence, inference). For example, a model can be generated via an automatic classifier system.

Proceeding to FIG. 6, an example wrapper system 610 is illustrated that can be employed to exchange data via a universal canvas. The system 610 is illustrated in a bifurcated manner, wherein communications and interactions between disparate object systems may occur from a first environment 620 to a second environment 622 and visa versa. It is noted that the first and second environments 620 and 622 may exist on the same system or may communicate remotely over a network, for example, and may include bridging between dissimilar objects belonging to one or more second systems and/or dissimilar objects belonging to one or more first systems. Although the following description generally relates to bridging between second and first object systems for exemplary purposes, it is to be appreciated that bridging can occur between other architecturally different object types.

The following description first details utilizing second objects from the first environment 620, wherein a first client 626 accesses services provided by a second object 628. When the first client 626 creates an instance of the second object 628, the second object 628 is exposed through a First Callable Wrapper (FCW) 630 that acts as a proxy for the second object 628. The FCW 630 is generally not “visible” within the second environment by other second classes/objects, however, the FCW 630 is utilized for marshaling calls between second and first code. This enables transparent interaction between the first and second environments and provides insulation from architectural differences between the environments. Thus, developers in one object system generally do not have to account for implementation details (e.g., design custom interface code) in the other object system. Each second object referenced outside the second environment 622 provides a single FCW regardless of the number of references that exist on the second object 628. This facilitates that a single object identity is shared between the FCW and the first client 626. It is to be appreciated that although the above discussion details a single first client and second object, a plurality of such clients/objects may be employed.

As described above, the FCW 630 may be viewed as a proxy for the second object 628 being referenced from the first environment 620. Thus, the FCW 630 is transparent to the second object 628 that is referenced by the FCW 630 in contrast to a second client. If multiple first clients (not shown) share a reference to the same second object 630, a bridging services component 632 can be provided to direct the multiple references to the same FCW 630. In other words, there should not exist more than one FCW 630 for any instance of the second object 628. The bridging services component 632 provides type information/conversion between the second and first environment to enable first clients to bind/interface to second objects and second clients to bind to first objects. During an activation process, the second environment 622 instantiates the second object 628 as well as the FCW 630.

In accordance with another aspect, a second client 638 may communicate and interact with a first object 640. When the second client 638 creates an instance of the first object 640, the first object and associated interfaces 642 are exposed through a second callable wrapper (SCW) 644 that acts as a proxy for the first object 640. Second wrappers appear to be like any other second class to the second client 638 but are utilized to marshal calls between second and first code. Objects being referenced outside the second environment will provide a single SCW 644 regardless of the number of references that exist on that object. This facilitates that a single object identity is shared between the SCW 644 and the first object 640. When the second client 638 loads the first object 640, the SCW 644 is created and appears like a second object to that client. The SCW 644 takes on one of two forms based on how the object was created.

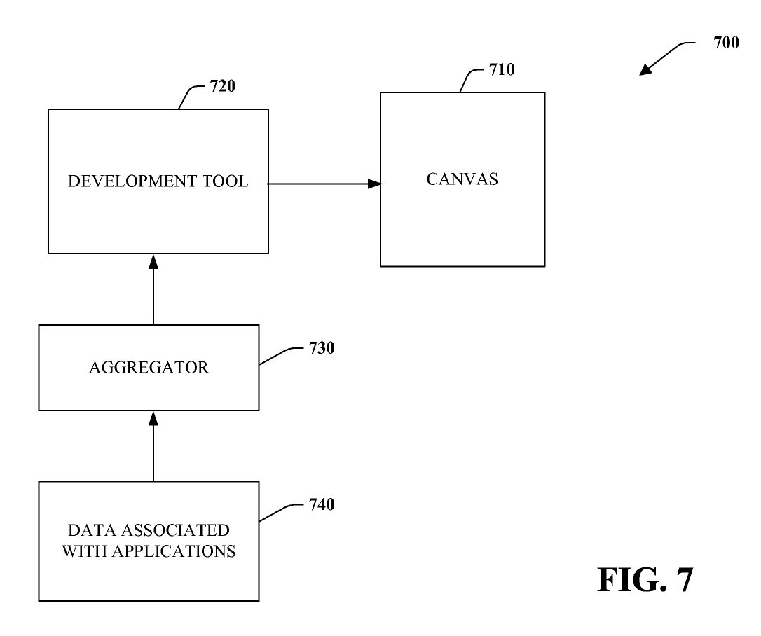

Referring now to FIG. 7, a system 700 illustrates a development tool for canvas applications and data structures. In this aspect, application data can be employed as part of a given application and further utilized to exchange data with other disparate applications. As shown, a canvas 710 which can be a local data store or remote database receives data from a development tool 720, where the tool allows access to and manipulation of data on the canvas. The development tool 720 can be driven from an aggregator component 730, where the aggregator component gathers data types, structures, and other data resources from various data sources. Data is associated with an application at 740 and collected via the aggregator 730 to form an input of data at 720 which is subsequently stored at the canvas or database 710. For example, one might dictate into a cell phone memory at 740 regarding an idea for a source code module that may be useful for other developers to know about. Data that is captured via the cell phone is collected at 730 is annotated with the source code application at 720 and subsequently stored at 710. The storage at 710 could be on the cell phone or wirelessly updated via the cell phone for example. When the database 710 is referenced in the future per selection by the respective application or user, one or more annotations 720 that have been previously stored can be retrieved and used to facilitate collaboration among developers or users of a document or application.

The development tool 720 and canvas 710 can be updated in several instances and likely via a user interface that is served from a remote server or on a respective mobile device if desired. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating the canvas 710 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user. The canvas 710 can be updated and stored in substantially any data format.

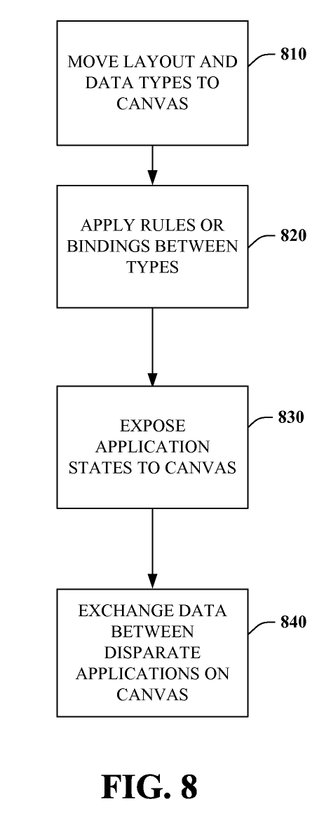

FIG. 8 illustrates an exemplary process 800 for exchanging data via a generic data model and canvas. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 810 of the process 800, data from applications is transferred on to a canvas or other memory structure that allows exchange of data between the applications where custom code is not developed to facilitate the data exchange. Thus, a generic data model is defined where objects that are exposed to the canvas are provided a generalized manner in which to send and receive data with other applications communicating with the canvas while mitigating the nuances of a given application. At 820, rules or bindings are applied to allow data exchanges between applications. As noted previously, various bindings or binding rules can be provided that describe how to map one or more data layout types with one or more data types. A layout describes the mapping of a file's data to the storage components that hold the data, where a layout is said to belong to a specific layout type.

The layout type allows for variants to handle different storage protocols. A data type defines a set of values, and the allowable operations on those values. Almost all programming languages explicitly include the notion of data type, though different languages may use different terminology. Most programming languages also allow the programmer to define additional data types, usually by combining multiple elements of other types and defining the valid operations of the new data type. The rules or binding at 820 can be associated with a canvas or other data structure to allow communications between various layout types and respective data types. It is noted that one or more data types can be bound to one or more layout types. In addition to layout types and data types that can be bound to each other, the canvas can provide other methods for mapping data between disparate applications.

At 830, states can be exchanged with the canvas. As noted previously, examples can include power-up states, initialization states, reset states, hold states, transmit data states, receive data states, request for rules or policies states, requests for particular types of data, data dump states, and so forth. At 840, after the various bindings and rules have been applied, data can be exchanged between one or more applications that have exposed one or more data structures to the canvas.

In addition to layout types and data types that can be bound to each other, the canvas can provide other methods for mapping data between disparate applications. As noted previously, one or more rules or policies can be provided that distribute information on the canvas (or other memory structure) on how to exchange data between various disparate applications. This can include providing rules or policies to an application on how to format data, how to transmit and receive data on the canvas, what type of data structures may be employed, what other type of application interfaces are available, what types of memory allocations are available, what data types may be in play, and substantially any rule or policy that communicates information to an application entering on to the canvass how to communicate with some other application that currently resides on the canvas.

In yet another aspect, transform components can be associated with applications when they are exposed to the canvas. For instance, upon first communications with the canvas, a data application can be instructed on how to format data when sending data to the canvas and what to expect when receiving data from the canvas. Thus, the application interacting with the canvas is provided with a generic interface that allows exchanging data from one application to another in an application-independent manner. This can include providing codes for different data types and structures, the amount of data that can be exchanged or stored on the canvas, the type of interfaces supported, various mappings that may be available between types and so forth. Also, and as noted previously, wrappers may be employed to exchange data in an application-independent manner.

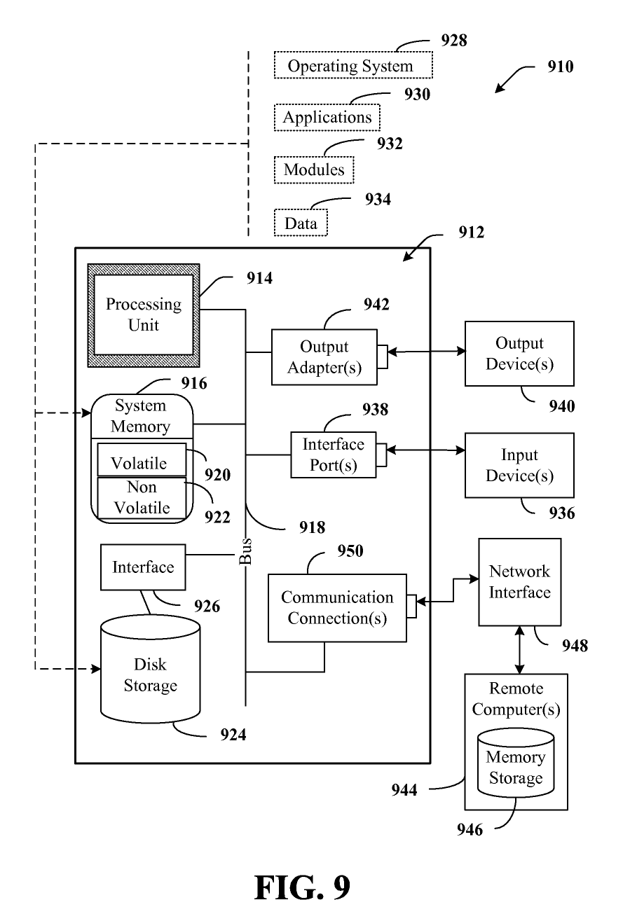

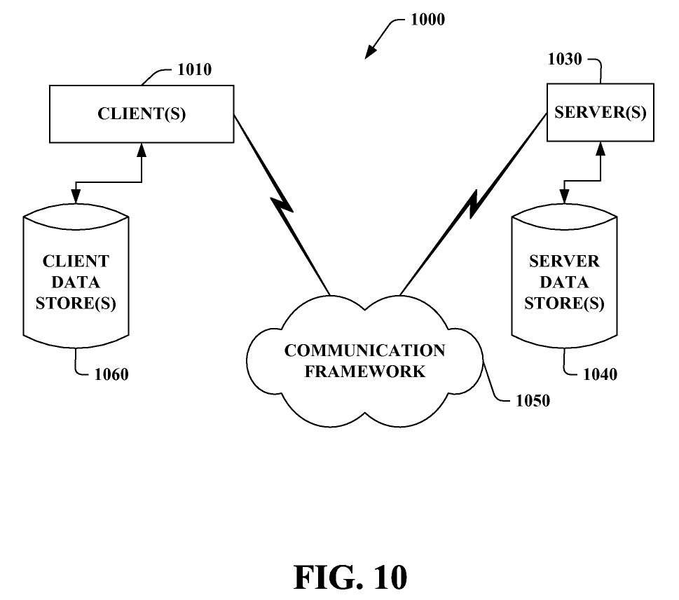

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A data processing system for data exchange across application boundaries, comprising:
a canvas memory in which to open multiple applications; and
a transform component to generate data structures across the canvas memory in at least one application form and to automatically transform the data structures to at least one other application form to mitigate application boundaries between disparate applications.

2. The system of claim 1, the canvas memory functions as a background buffer component in a computer system.

3. The system of claim 2, the canvas memory exists inside of at least one application that can be accessed by at least one other application.

4. The system of claim 1, further comprising a rules and policies component for manipulating data on the canvas memory.

5. The system of claim 1, further comprising a wrapper to exchange data between applications.

6. The system of claim 1, further comprising at least one layout type and at least one data type that is associated with the canvas memory.

7. The system of claim 6, further comprising a binding component to map layout type and the binding type.

8. The system of claim 1, a state component to share state information between an application and the canvas memory.

9. The system of claim 1, further comprising a monitor component to automatically determine rules and policies for the canvas memory.

10. The system of claim 9, the monitor component includes a learning component to automatically determine the rules and policies for the canvas memory, where learning is associated with native data or an application, or where learning is associated on a canvas that supports pre-fetching based on history.

11. The system of claim 1, further comprising one or more links that are embedded regarding the source of data.

12. The system of claim 11, further comprising a tool that allows a user to drill down to bring up portions of an application to process a selected data structure.

13. The system of claim 12, further comprising a tagging component to indicate where data originated.

14. The system of claim 13, further comprising a component to provide multiple data views.

15. The system of claim 14, further comprising a component that provides data to a user that is most likely to be the next piece of data needed via pre-fetching user interface.

16. The system of claim 15, further comprising a filter component that hides data that is not relevant to a current context.

17. A method to share data across a common memory, comprising:
providing a memory surface to enable data structures to be placed on the surface;
defining one or more layout types for the data structures;
determining one or more binding rules to associate the layout types with the data structures; and
automatically exchanging data across the memory surface between data structures associated with at least two disparate applications.

18. The method of claim 17, further comprising a state component to exchange application states between the at least two disparate applications.

19. The method of claim 17, further comprising automatically transforming data to a different form across the memory surface.

20. A data communications system, comprising:
means for providing a layout of one or more data structures;
means for defining a type for one or more data structures;
means for binding the layout and the type for the one or more data structures; and
means for exchanging data between the data structures, where the data structures are associated with at least two different applications.
